(19) United States
(12) Patent Application Publication
(10) Pub. No.: US 2014/0127707 A1
(43) Pub. Date: May 8, 2014

(54) SUBJECT INFORMATION ACQUIRING APPARATUS AND METHOD

(71) Applicant: CANON KABUSHIKI KAISHA, Tokyo (JP)

(72) Inventors: Toshihiko Ouchi, Machida-shi (JP); Sayuri Yamaguchi, Tokyo (JP)

(73) Assignee: CANON KABUSHIKI KAISHA, Tokyo (JP)

(21) Appl. No.: 14/068,162

(22) Filed: Oct. 31, 2013

(30) Foreign Application Priority Data
Nov. 4, 2012 (JP) 2012-243215
Oct. 4, 2013 (JP) 2013-209339

(51) Int. Cl. G01N 21/17

(52) U.S. Cl. CPC G01N 21/17
USPC 435/7.1; 435/288.7

(57) ABSTRACT

A subject information acquiring apparatus including: a generation section that generates terahertz waves to be irradiated at a test object in a plurality of kinds of states including a state in which a target material that takes a specific portion of the test object as a target has been introduced into the test object; a detection section that detects terahertz waves that are propagated from the test object and outputs a signal; a processing section that acquires information of the test object using the signals detected by the detecting section and information relating to a characteristic portion of a wavelength spectrum of the target material.

### BACKGROUND OF THE INVENTION

1. Field of the Invention

The present invention relates to a subject information acquiring apparatus such as an image forming apparatus that forms an image of a test object using electromagnetic waves in the terahertz (THz) band (frequency between about 30 GHz and 30 THZ), and a subject information acquiring method. More specifically, the present invention relates to an apparatus and a method that detect, for example, a specific portion on the surface of or inside an organism.

2. Description of the Related Art

In recent years, non-destructive sensing technology has been developed that uses electromagnetic waves in the terahertz band (hereinafter also referred to as “terahertz waves”). As fields of application of electromagnetic radiation in the aforementioned frequency band, technology that performs imaging with a safe fluoroscopic apparatus instead of X-rays, and spectroscopy technology for acquiring an absorption spectrum and complex dielectric constant of a substance to inspect physical properties such as a bonding state of molecules thereof have been developed. Measuring technology for inspecting physical properties such as carrier concentration or mobility and conductivity, and analytic technology for analyzing biomolecules are also being developed. Among such technology, as technology that performs fluoroscopic imaging of an object using terahertz waves, a terahertz time domain spectroscopy apparatus (THz-TDS) has been proposed that uses terahertz wave pulses that are generated by irradiating an ultrashort pulse laser beam at a semiconductor or the like (see Japanese Patent No. 3387721). According to the technology proposed in Japanese Patent No. 3387721, terahertz wave pulse signals pass through separate places of an object spatially, and the object is imaged using received signals. If reflected terahertz waves are used, tomographic images of the inside of the object and the like can be acquired.

However, when a specific portion on the surface of or inside an organism is observed and image forming is performed using the above described technology, in some cases the detection sensitivity of the terahertz waves deteriorates due to attenuation of electromagnetic waves that is caused by absorption of the electromagnetic waves by the test object or scattering of the electromagnetic waves due to a rough shape of the surface or the like. Although this similarly applies with respect to imaging that uses light in general, it is particularly a problem when imaging with terahertz waves because the level of absorption by moisture and the like is large. With respect to imaging that uses light, technology is being developed that improves the detection sensitivity of a specific portion by using a molecular probe that accumulates at the specific portion and has sensitivity to light of a specific wavelength (see Nature Rev. Cancer 2, p. 750).

In an image forming apparatus that uses terahertz waves, as described in the foregoing, the intensity of a signal for acquiring an image is liable to deteriorate when imaging an object for which there is a large amount of absorption or scattering. In a case where signals are comparatively large also, it is desirable to improve the sensitivity in order to perform image formation more quickly. This is because the cumulative time can be decreased in the case of reducing random noise by performing measurement multiple times with respect to the same point and integrating the results to improve the signal-to-noise ratio of detected terahertz wave signals. The demand to improve the sensitivity as described above for detection using terahertz waves is particularly noticeable in a case where there is a small permittivity difference between regions to be distinguished in a test object. However, with respect to detection that uses terahertz waves, technology has not been established that improves distinguishability of such regions by means of a method such as use of a molecular probe when performing image formation or the like for a test object using a characteristic spectrum of the regions.

### SUMMARY OF THE INVENTION

In view of the above problem, there is provided a subject information acquiring apparatus including: a generation section that generates terahertz waves to be irradiated at a test object in a plurality of kinds of states including a state in which a target material that takes a specific portion of the test object as a target has been introduced into the test object; a detection section that detects terahertz waves that are propagated from the test object and outputs a signal; a processing section that acquires information of the test object using the signals detected by the detecting section and information relating to a characteristic portion of a wavelength spectrum of the target material.

According to another aspect of the present invention, there is provided a subject information acquiring method, including: irradiating terahertz waves at a test object in a plurality of kinds of states including a state in which a target material that takes a specific portion of the test object as a target is introduced into the test object; detecting terahertz waves that are propagated from the test object; providing data including information relating to a characteristic portion of a wavelength spectrum of the target material; and acquiring information of the test object using signal of the detected terahertz wave and the provided data.

Further features of the present invention will become apparent from the following description of exemplary embodiments with reference to the attached drawings.

### BRIEF DESCRIPTION OF THE DRAWINGS

FIG. 1 is a diagram that illustrates the overall configuration of an image forming apparatus of Embodiment 1 according to the present invention.

FIGS. 2A and 2B are views that illustrate an example of an observation cross-section and a terahertz waveform according to Embodiment 1 of the present invention.

FIGS. 3A, 3B and 3C are views for describing the state of terahertz wave pulses according to Embodiment 1 of the present invention.

FIG. 4 is a view that illustrates an example of tomographic observation according to Embodiment 1 of the present invention.

FIGS. 5A, 5B and 5C are views that illustrate examples of the spectra of target molecules according to the present invention.

FIGS. 6A, 6B and 6C are views that illustrate examples of measurement of a phantom using target molecules according to Embodiment 1 of the present invention.

FIG. 7 is a view for describing the flow of a measurement process according to Embodiment 1 of the present invention.

FIGS. 8A and 8B are diagrams that illustrate the overall configuration of an image forming apparatus of Embodiment 2 according to the present invention.

FIG. 9 is a view for describing a probe section of Embodiment 3 according to the present invention.

FIG. 10 is a view for describing a probe section of Embodiment 4 according to the present invention.

FIGS. 11A and 11B are views that illustrate a terahertz reflectivity database of Embodiment 1 according to the present invention.

### DESCRIPTION OF THE EMBODIMENTS

Preferred embodiments of the present invention will now be described in detail in accordance with the accompanying drawings.

An object of the present invention is, with respect to observation or acquisition of information of a test object such as biological tissue, to improve information acquisition performance such as imaging sensitivity by combined use of spectral information in the terahertz region of a test object and spectral information of a target material that accumulates at an observation site. To improve the distinguishability of a site of a test object, terahertz waves are irradiated at the test object in a plurality of kinds of states including a state in which a target material that takes a specific portion of the test object as a target has been introduced into the test object, and terahertz waves that are propagated back from the test object are detected. Note that in the present specification the term “target material” is defined as including both an object that remains by selectively bonding or the like by taking the aforementioned specific portion as a target, and an object that selectively remains at a place other than a specific portion. Although information is obtained by performing processing using data that includes information of a characteristic portion of the wavelength spectrum of a target material and detected signal, the kinds of data and terahertz waves and the manner of processing vary depending on which kinds of information (image information, information regarding identification or presence/absence of a specific portion and the like) are acquired with respect to the test object. For example, the intensity or pulse width of a terahertz wave to be irradiated onto a test object can be changed in accordance with the site it is desired to image.

Further, tissue imaging can be used to observe a steady state of a test object and identify a region of an abnormal site, and regions that dynamically change upon injection of a pharmaceutical agent (a molecular probe, a therapeutic agent, a molecular target drug or the like) that accumulates at an abnormal site or is excluded from an abnormal site can be screened. At such time, the sensitivity can be improved by performing spectral filter processing with respect to the target material that is used.

Embodiments of the present invention are described hereunder.

### Embodiment 1

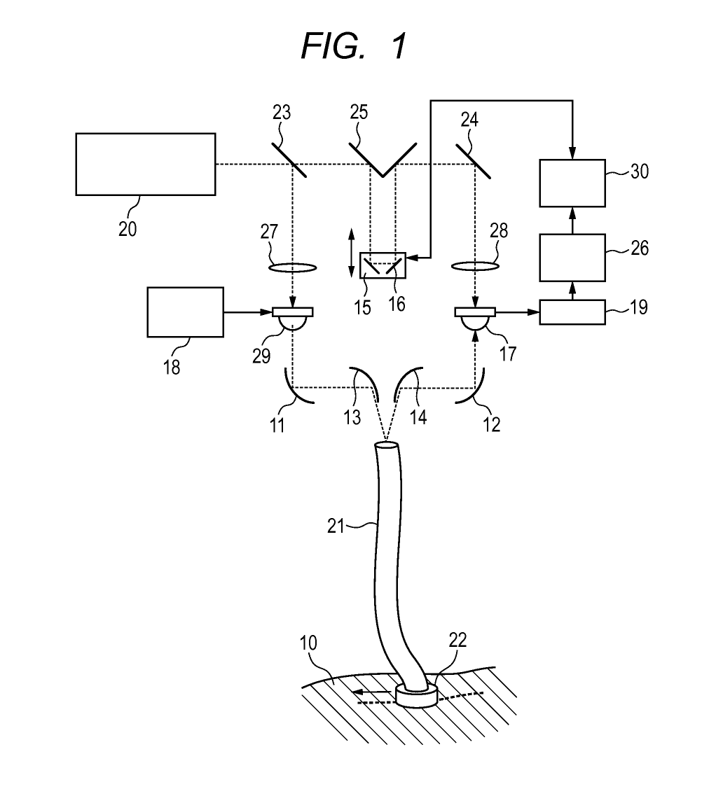

Embodiment 1 according to the present invention will be described using FIG. 1 to FIG. 7. According to the present embodiment, a terahertz time domain spectroscopy apparatus (THz-TDS) is employed that uses terahertz wave pulses. Terahertz waves are irradiated at a test object 10 using a probe 21, and terahertz waves from the test object 10 can similarly be detected using the probe 21.

The configuration shown in FIG. 1 is that of a common THz-TDS device. A laser beam having a pulse width of about 100 fsecs or less emitted from a femtosecond laser 20 is split into two beams by a half mirror 23. One of the resulting beams is condensed by a lens 27 and projected onto a photoconductive element 29. A bias voltage applied to the photoconductive element 29 that constitutes a terahertz wave generation section is modulated by a power source 18. The modulated terahertz wave is introduced into the terahertz waveguide (probe) 21 by parabolic mirrors 11 and 13. A form may also be adopted in which the terahertz wave is irradiated onto the test object 10 without using a waveguide. The other laser beam obtained by splitting at the half mirror 23 is subjected to delay control by a fixed pair of mirrors 25 and a pair of mirrors 16 mounted on a movable delay stage 15, and thereafter is projected via a mirror 24 and a lens 28 onto a detection-side photoconductive element 17 constituting a detection section that detects terahertz waves. A control signal of the delay stage 15 is output from a control and processing section 30 that processes detected signals. As described above, the subject information acquiring apparatus of the present embodiment that is a terahertz time domain spectroscopy apparatus includes the generation section 29 that generates terahertz waves to be irradiated at a test object in a plurality of kinds of states including a state in which a target material, described later, that takes a specific portion of the test object as a target has been introduced into the test object. The subject information acquiring apparatus of the present embodiment also includes the detection section 17 that detects terahertz waves that are propagated back from the test object and outputs a signal, and the control and processing section 30 that is a processing section that acquires information such as an image of the test object using detected signals and data including information relating to a characteristic portion of a wavelength spectrum of the target material that is described later.

The terahertz waveguide 21 may be formed using a material such as a hollow fiber having a metal coat inside, or a photonic crystal fiber having a periodical hole structure. A metal single wire, a waveguide tube, a two-conductor wire like a coaxial line or a balanced line, and the aforementioned materials coated with a resin may also be used as the terahertz waveguide 21. A window (not shown) or the like such as a quartz plate, a silicon plate or a resin plate may be provided at a distal end section 22 of the probe 21 made of fiber or the like to enable separation of the probe 21 from the test object 10. A terahertz wave propagated along the probe 21 is irradiated onto the test object 10, and a reflected wave thereof propagates along the probe 21 and is detected by the photoconductive element 17 via parabolic mirrors 14 and 12. Although in the example shown in FIG. 1 the introduction and emission of the terahertz wave is conducted using two parabolic mirrors 13 and 14 spatially, a method using a lens or a form in which the terahertz waveguide 21 is directly connected to the generation section 29 and the detection section 17 may also be adopted.

The signal of the terahertz wave is detected via an amplifier 19 and a lock-in amplifier 26, and the signal is converted into information such as image information at the control and processing section 30. An image of the test object 10 can be formed by acquiring image information while scanning the probe 21.

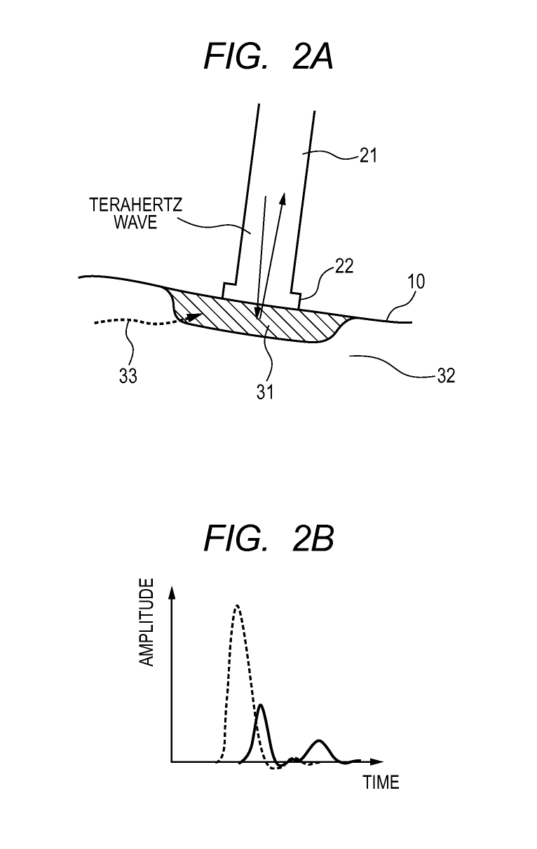

FIG. 2A illustrates a cross-sectional view that includes the probe 21 taken along a dashed line in the vicinity of the test object in FIG. 1. In this case, it is assumed that the test object is biological tissue. In the image in FIG. 2A, in a certain region from the surface to a deep part of the biological tissue 10 that is the test object, an abnormal tissue portion 31 such as a tumor that is a specific portion exists along with a normal tissue portion 32. It is known that in such a case the spectral characteristics in the terahertz region of the abnormal tissue portion 31 and the normal tissue portion 32 differ. Hence, if values of permittivity spectra that were previously measured are stored in a storage section as a database, by referring to the database and processing the detected signals of the photoconductive element 17 it is possible to obtain a tomogram in which a difference in the states of tissues as shown in FIG. 2A has been distinguished. Such a storage section can be provided in the control and processing section 30 shown in FIG. 1.

An example of the waveform of a reference terahertz wave pulse at such time is illustrated in FIG. 2B. FIG. 2B illustrates a reference waveform (broken line) when a mirror was placed under the probe instead of a test object, and a waveform (solid line) when the test object was placed under the probe. A terahertz reference waveform is typically an electromagnetic field pulse with a half-value width of approximately 350 fs (see the broken line portion in FIG. 2B), and includes a component between approximately 0.2 THz and 4 THz as a Fourier frequency component. A known spectroscopy technique using a THz-TDS device can calculate the frequency dependency of a complex refractive index of the test object based on the transmission or reflection response with respect to such an electromagnetic field pulse.

The terahertz wave penetrates to a certain degree into the test object (approximately 100 μm to several mm in the case of a living organism), and if there is a discontinuous face of the refractive index, a reflected pulse produced by scattering at the surface and discontinuous interface is observed (see the solid line portion in FIG. 2B). Qualitatively, the waveform of the reflected pulse is determined by the refractive index of a propagation region of the terahertz wave that penetrated into the test object and a distance to the reflection interface. Therefore, conversely, it is possible to also identify the internal structure and distinguish the constituent tissue by analyzing the pulse waveform. Quantitatively, as described above, analysis can be conducted using a method that measures a complex refractive index with respect to a terahertz wave of each site of a test object in advance and reconstructs a multilayer structure using the transfer matrix method. The transfer matrix method is a method that, when a film structure (film thickness, refractive index, order of layering, number of layers and the like) is given, precisely calculates a reflectance (transmission) spectrum of a dielectric multilayer film, and it is possible to use this method in reverse to reconstruct a multilayer structure based on a measured spectrum. The description up to this point has described a method that utilizes only information of a complex refractive index of a test object and does not use a target material.

Here, to improve the sensitivity with respect to distinguishing abnormal tissue and normal tissue, a target molecule 33 is introduced to serve as a target material as illustrated in FIG. 2A. As used herein, the term “target material” is defined as an object that has a characteristic frequency spectrum in the terahertz region and for which a concentration thereof can be caused to differ between a specific portion of a test object and a site other than the specific portion that it is desired to distinguish. Such target materials also include pharmaceuticals referred to as “molecular target drugs” and molecules that selectively bond to ligands included in a specific portion by an antigen-antibody reaction.

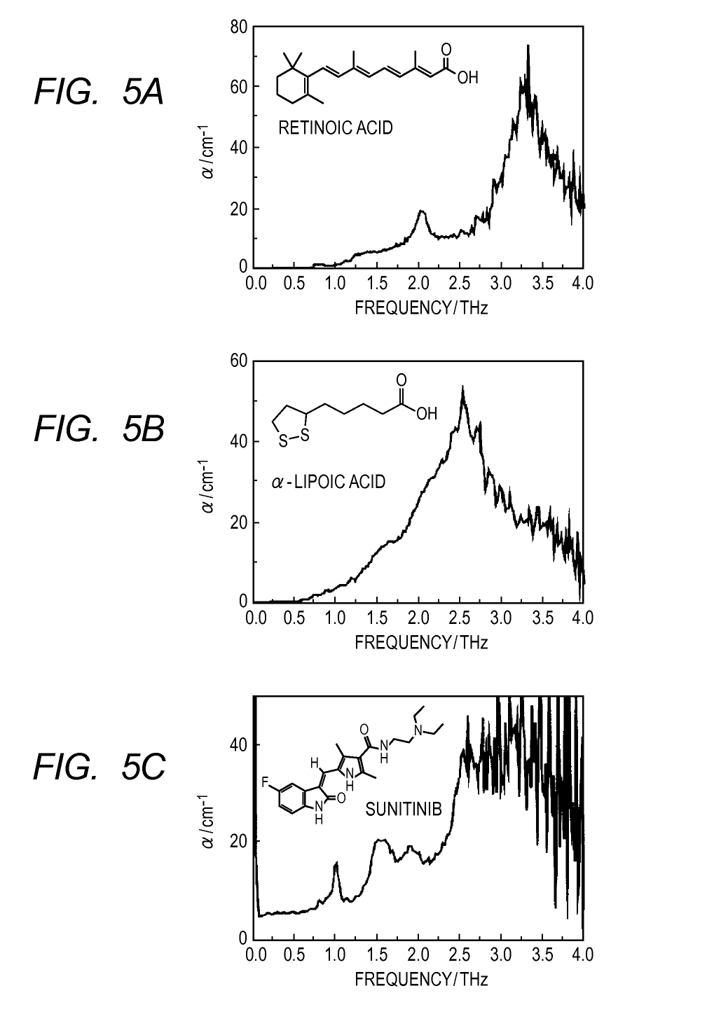

As examples of target molecules that serve as target materials, the absorption spectra in the terahertz region of retinoic acid as illustrated in FIG. 5A, α-lipoic acid as illustrated in FIG. 5B, and sunitinib as illustrated in FIG. 5C have different characteristics to each other. These target molecules have the following efficacies as pharmaceuticals, respectively.

Retinoic acid: therapeutic agent for leukemia, transdermal therapeutic agent for wrinkles and acne.

α-lipoic acid: transdermal therapeutic agent for anti-aging.

Sunitinib: anticancer agent for kidney cancer (molecular target drug).

As examples of target molecules that serve as These substances can function as the above described target molecules as the result of a difference in the concentration thereof between an abnormal site and a normal site of human tissue appearing due to a difference in the excretion speed after administration.

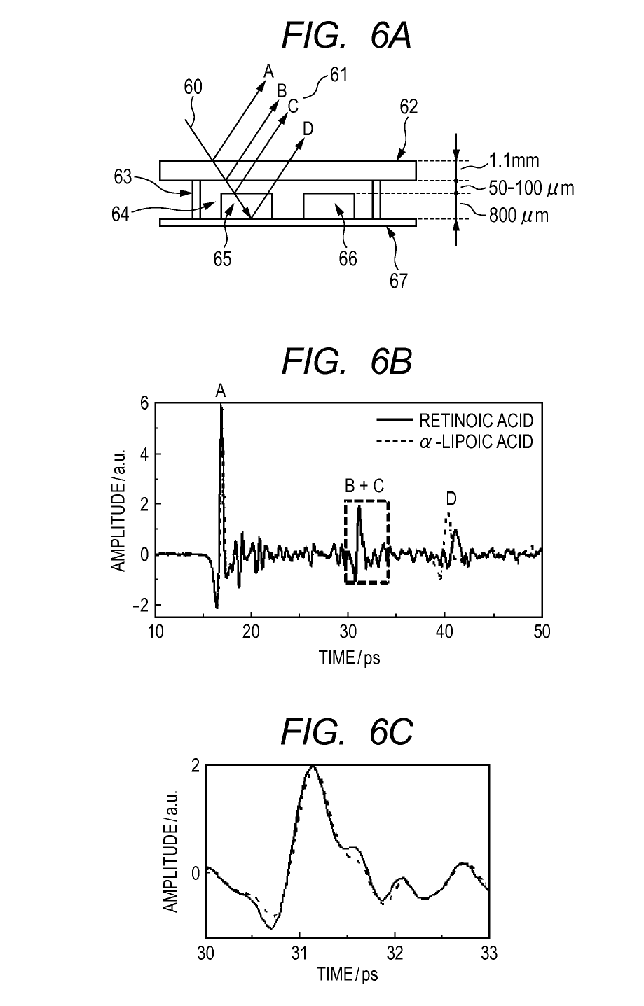

An experimental example using a phantom as illustrated in FIG. 6A in which retinoic acid and α-lipoic acid were used as target molecules will now be described. The phantom was constructed by embedding pellets 65 and 66 including the aforementioned two target molecules in a gelatin solution 64 obtained by dissolving gelatin at a concentration of 40% by weight in water, and sealing the gelatin solution using a quartz plate 62, a substrate 67 and spacers 63. A terahertz wave 60 was caused to be incident thereon from above, and reflected waves 61 were detected. This gelatin has a characteristic (complex refractive index) in the terahertz band that is close to human tissue. When pulses 61 reflected when the terahertz wave 60 was irradiated onto the phantom were observed, the spectrums shown in FIG. 6B and FIG. 6C were obtained. FIG. 6B illustrates waveforms over the entire measurement time period, and it is found that there are reflected pulses at a plurality of interfaces. The respective reflected pulses are pulses from interfaces corresponding to A, B, C and D in FIG. 6A. Although four reflected pulses can be seen, since the interface distance between B and C is equal to or less than 100 μm, these reflected pulses are observed as though the signals are overlapping. FIG. 6C illustrates waveforms in which reflected pulse portions of the gelatin and target molecules corresponding to B and C are enlarged. Based on FIG. 6C, it is found that there is a difference between the waveforms of the retinoic acid and the α-lipoic acid. The difference seen in FIG. 6C reflects the difference between FIG. 5A and FIG. 5B. When the optical spectrum of such target molecules and spectral characteristics of other sites are previously acquired and stored in a storage section, even in the case of a multilayer structure such as the present phantom, fitting of reflected waveforms can be performed using the transfer matrix method or the like. According to the present experimental example, it was confirmed that identification of the respective target molecules can be performed by fitting, and even when it is difficult to distinguish the target molecules using only a difference between the refractive indices of the target molecules, the sensitivity can be improved using a difference between the spectrums of the target molecules. That is, with respect to sites such as those denoted by reference numerals 65 and 66 in a test object that are difficult to detect as they are, it was found that detection and measurement with favorable sensitivity can be realized by using one or more target materials for which a residual concentration at these sites is selectively large.

When target molecules are introduced into a test object in this manner, the sensitivity of distinguishing sites by means of terahertz waves can be improved as the result of differences appearing in the concentration of the target molecules at respective sites of the test object. However, in such case a characteristic is detected that is different to the complex refractive index that the test object substance originally possesses. Accordingly, it is also meaningful to acquire and compare detection data that is obtained based on a terahertz wave before and after introduction of target molecules or after the target molecules are completely excreted after being introduced. In this case, as described above, the distinction sensitivity will differ depending on the presence or absence of the target molecules. Therefore, it is good to change the amplitude or intensity of the terahertz wave between a case in which target molecules were introduced and a case where target molecules were not introduced, that it, to make the amplitude or intensity smaller in the former case and larger in the latter case

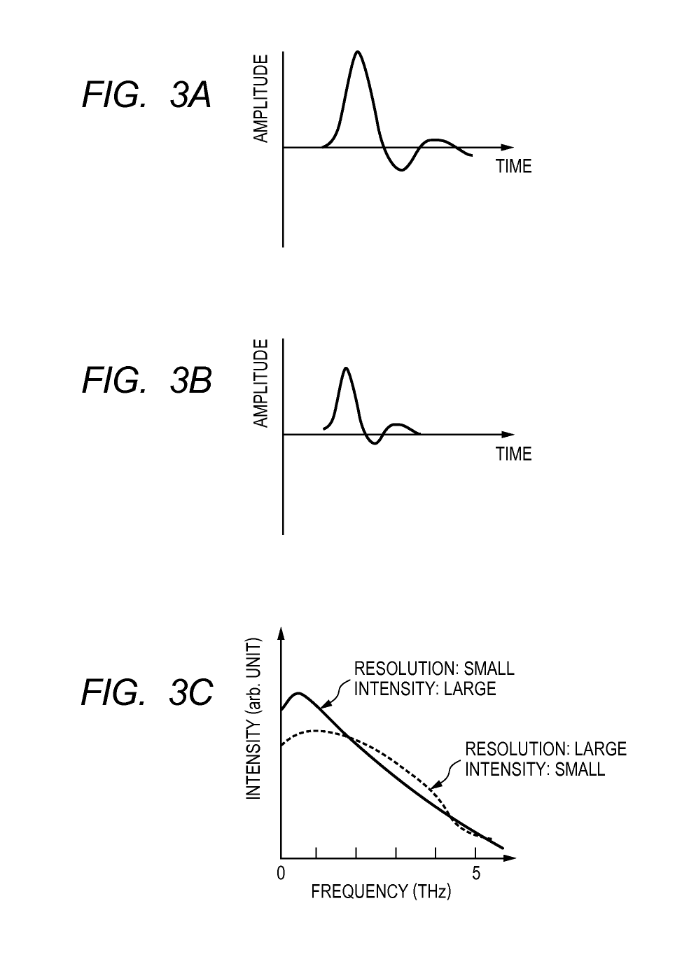

In general, in the case of the THz-TDS technique, although a terahertz wave pulse is used, a trade-off relationship exists between the size of the terahertz wave amplitude and the pulse width. This will now be described using FIG. 1, FIG. 3A, FIG. 3B and FIG. 3C. According to the THz-TDS technique, to increase the amplitude value of a terahertz wave pulse, a voltage value (an amplitude value in the case of supplying a modulating signal for synchronous detection at the lock-in amplifier 26) that is supplied by the bias power source 18 to the photoconductive element 29 on the terahertz generation side in FIG. 1 is increased. Alternatively, a method is available that increases the optical excitation power from the femtosecond laser 20 and the like. With respect to the voltage, if the photoconductive element uses low-temperature-grown GaAs, a voltage of around 20 V is typically applied, although it is possible to increase the voltage to approximately 100 V. Fundamentally, the amplitude of the terahertz wave increases in proportion to the increase in voltage. On the other hand, although a different crystal system such as low-temperature-grown InGaAs is sometimes used, in such cases, because the resistance may be low, there are also cases where the voltage is a maximum of about 20 V. Typically an output of around 10 to 30 mW is suitable with respect to the excitation light output, and within that range the amplitude value of the terahertz wave increases proportionally. However, the amplitude value of the terahertz wave tends to saturate with respect to an increase in the excitation light output of 30 mW or larger, and it is not preferable to allow the amplitude value of the terahertz wave to saturate. However, by arranging the photoconductive elements in an array shape, it is possible to increase saturation output with respect to the excitation light power, and obtain a larger amplitude of the terahertz wave pulse.

Although the terahertz wave amplitude can be increased and decreased using the excitation light power with respect to the photoconductive element 17 on the terahertz detection side also, the amplitude does not change markedly compared to the degree to which the amplitude changes on the generation side. In general, the excitation light power is changed in a range between about 1 to 10 mW. The typical values for optical output and voltage described above are based on the assumption of using a femtosecond laser beam having a wavelength of approximately 800 nm in the case of GaAs, and using a femtosecond laser beam having a wavelength in the 1500 nm band in the case of InGaAs. With respect to GaAs, it is also possible to generate or cause detection of a terahertz wave using a laser beam in the 1500 nm band using a nonlinear phenomenon, and in such a case the typical values will increase somewhat relative to the above described values.

Thus, the amplitude value of a terahertz wave can be adjusted by characteristic driving units of the THz-TDS device. However, as described in the foregoing, there is a trade-off between the terahertz wave amplitude and resolution. This is because there is a tendency for the pulse width to increase due to an increase in the amplitude and this leads to an increase in components with a long wavelength. As described above, when one or both of the voltage and excitation light intensity of a photoconductive element is increased to increase the amplitude value of a terahertz wave pulse, there is a tendency for the pulse width to increase. For example, in the case illustrated in FIG. 3A in which the amplitude value was increased, the pulse width is 380 fs, a Fourier frequency spectrum thereof has a peak at 0.6 THz, and the terahertz wave pulse has many components in the low frequency region also. This situation is represented by the solid line portion in FIG. 3C. In contrast, as shown in FIG. 3B, when the amplitude value of the terahertz wave pulse is decreased, for example, to about ⅕, the Fourier frequency spectrum can be made to have a peak at 1 THz with a pulse width of 300 fs depending on the adjustment. In this case, the higher the peak value of the Fourier frequency spectrum is, the greater the amount of high frequency components, that is, components with a short wavelength, that are included, and hence the spatial resolution of imaging (image acquisition) by means of the terahertz wave increases. In the above described example, it is possible to make the resolution about 1 mm with the high pulse amplitude, and about 0.5 mm with the low pulse amplitude. However, these values are representative values of the THz-TDS device used in the present embodiment. These values vary according to the design of the optical system, that is, the diameter of the lens, the NA (numerical aperture) and the focal length, and the diameter of a parabolic mirror, the NA and the focal length of the THz optical system and the like, as well as the specifications of a photoconductive element and an excitation laser that are used. Thus, the aforementioned driving parameters illustrate the tendency using one example, and the present invention is not limited to the aforementioned driving parameters.

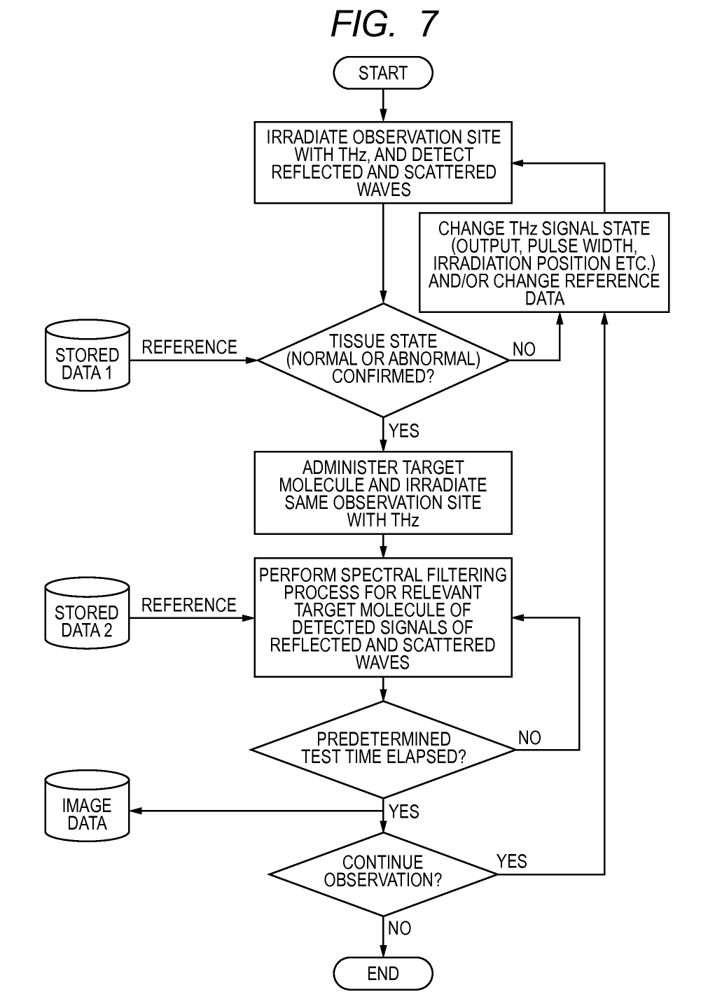

FIG. 7 illustrates a flowchart showing the flow of measurement operations with respect to a test object into which target materials are introduced in a case where the intensity of the terahertz wave is changed and the resolution also changes as described above. It is assumed as a premise that various databases exist with respect to the test object and target materials. In the case illustrated in FIG. 7, refractive index data for the terahertz wave band for an abnormal site and a normal site of biological tissue was prepared (stored data 1). Further, data of characteristic spectrums in the terahertz wave band of the target molecules that are introduced, and data for performing spectral filter processing that extracts components of only characteristic spectrum portions created based on the characteristic spectrums are prepared (stored data 2). Such data may be obtained by identifying the complex refractive index of each substance beforehand by measuring the transmittance in a similar manner with the THz-TDS device and storing the data in a storage section of the device. Further, the stored data may be data that can be replaced in various ways by exchanging a storage section in the device or data that is obtained via a system (cloud system or the like) by reading out required data as appropriate from a server over a network.

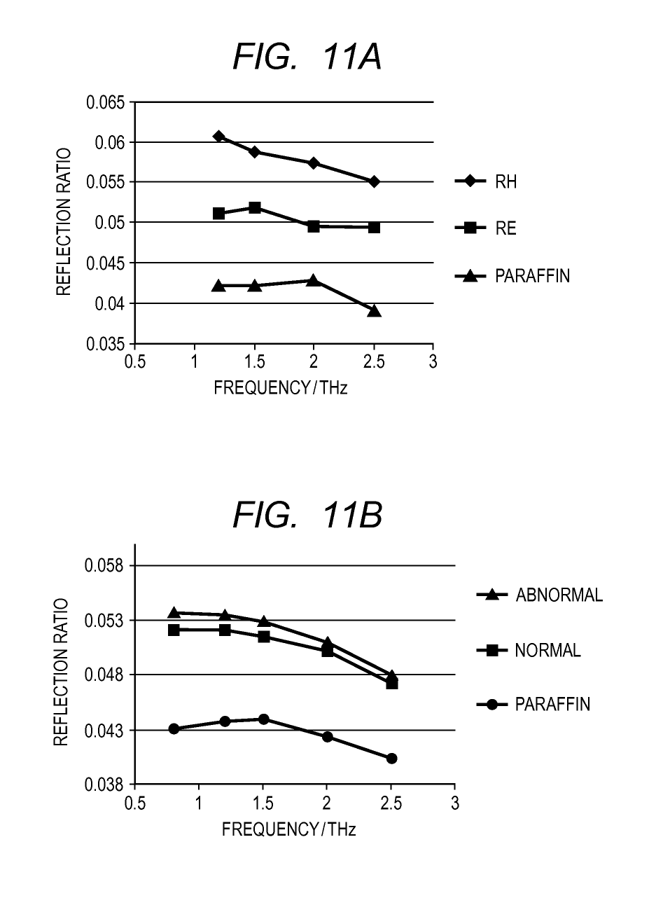

The two graphs shown in FIGS. 11A and 11B are examples of databases when biological tissue is taken as a test object, and illustrate data analysis results with respect to reflectivity in a terahertz region (approximately 0.5 THz to 2.5 THz) of a fixed liver section. FIG. 11A is a graph of reflectivity calculated while determining respective ratios by image analysis by means of visible images in a case where samples obtained by thinly slicing (thickness between approximately 3 and 5 μm) the surface of the sample to be observed were stained with hematoxylin (H) and eosin (E), in which the reflectivity of a region corresponding to a portion stained with H is denoted by reference characters “RH” and the reflectivity of a region corresponding to a portion stained with E is denoted by reference characters “RE”, and the reflectivity of paraffin is taken as the reflectivity of the other regions that were not stained. Based on the graph, it is found that RH has the highest value. This indicates that the reflectivity of the tissue stained with H, that is, tissue composed principally of the cell nucleus, is higher than the reflectivity of other tissue such as the cytoplasm.

It is generally considered that the proportion of a cell occupied by the cell nucleus increases in a cancer region, and as a result the reflectivity in a cancer region is higher than in a normal region. Actual analysis results are illustrated in FIG. 11B. The results illustrated in FIG. 11B show that the terahertz reflectivity at an abnormal site, that is a cancer site, is higher than at a normal site, although the ratio is only slightly higher. As will be understood from FIG. 11B, the difference is a slight difference, and in order to prevent a situation in which the difference can not be distinguished due to a measurement error or the like, the terahertz amplitude value is raised while lowering the spatial resolution, and thus the state of the tissue prior to introducing a target molecule is grasped. Although a formalin-fixed paraffin-embedded sample that is used in normal pathological examinations is used in this case, similar results can be acquired using a live slice. In-vivo application is also possible.

In FIG. 7, first, a terahertz wave is irradiated at an observation site of the test object using the THz-TDS device, and waves that are reflected and scattered therefrom are detected. Next, the stored data 1 is referred to and the detected signal is linked with the stored data 1 is performed. That is, in this case, image acquisition with respect to the test object is performed while distinguishing whether the tissue is a normal site or an abnormal site, and image acquisition that also includes the distribution of the tissue state is performed. At this time, if it is not possible to adequately distinguish whether the tissue is a normal site or an abnormal site, although the spatial resolution will decrease, the terahertz wave amplitude is increased using the aforementioned method to increase the detection signal intensity and thus enable distinguishing of the site. Further, scanning of the irradiation position is performed for image acquisition, and depth direction information is also acquired. The stored data that is referred to is also changed as appropriate.

When image data as the measurement result has been acquired for the entire test object, the tissue state identification process ends, and the operation advances to the next step of administering a target molecule. Scanning of the irradiation position is performed while irradiating a terahertz wave at the same region of the test object as in the tissue state identification process. At this time, since the administered target molecule is known, data for spectral filter processing thereof is referred to in the stored data 2 and signal processing is performed. In the present embodiment, the signal processing is performed using software. Such software can be installed, for example, in a memory provided in the control and processing section 30. At this time, as described above, since the sensitivity with respect to distinguishing abnormal and normal sites is improved, the amplitude value of the terahertz wave to be irradiated can be decreased to increase the spatial resolution. Where necessary, image data may be acquired repeatedly within the time period of the process from administration of the target molecule until the target molecule is excreted. This is indicated in the next step, in which it is determined whether or not to continue with a subsequent observation after a predetermined test time has elapsed. For example, in a case where tissue is removed by surgery, surfaces from which tissue is excised can be observed in succession by the apparatus according to the present invention, thereby providing support for checking whether all the tissue has been appropriately removed. If necessary, in order to measure a different site, the reference data can be changed and the operation can returns to the initial process of detecting a terahertz image without a target molecule. If the process is completed, the series of measurements ends.

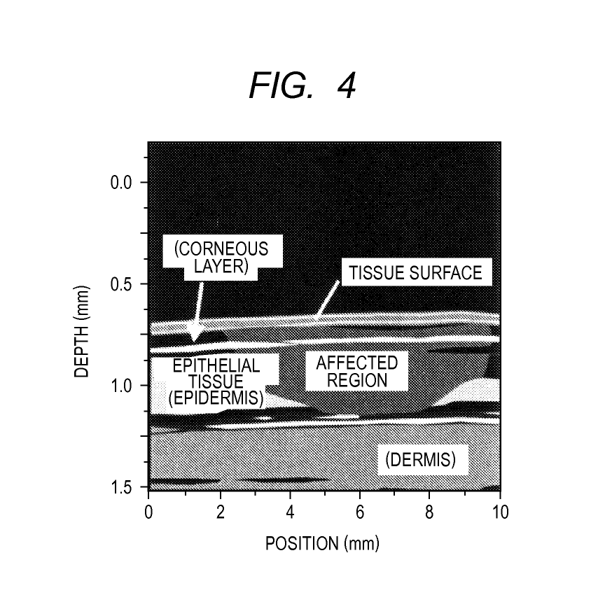

An observation example of a tomography image that can be acquired in the manner described above is illustrated in FIG. 4. This example illustrates a tomogram when a transdermally absorbable drug was administered onto the surface of skin (tissue surface), and spectral imaging of the respective interfaces of the corneum layer, epidermis, and dermis as well the affected region was performed. It is found that the affected region as the specific portion can be distinguished in the depth direction. In practice, with respect to terahertz imaging, it is also possible to form a three-dimensional image by processing.

A target molecule used in this case may be an anticancer agent referred to as a “molecular target drug” such as sunitinib that is described above. When using sunitinib, because sunitinib is a target drug for renal cancer, it is possible to selectively introduce sunitinib into a cancer site and observe the kidney by the above described method. In the case of observing an internal organ in this manner, the probe 21 can be formed as an endoscope structure or the probe can be embedded in a catheter or the like. Observation may also be performed by placing the probe against an affected part when performing a laparotomy. Note that this probe may also be formed as a structure that includes not just a terahertz-wave propagation function, but simultaneously includes different physical means such as light or ultrasound, and may include a measurement function that utilizes a different modality to terahertz waves.

In addition, substances that have been used practically as target molecules with other modalities before now can also be utilized for terahertz imaging.

For example, substances that are often commonly used as fluorophore molecules include indocyanine green and fluorescein. The former is a molecular probe that binds with globulin that is a protein in blood, and raises the visibility of locations where new blood vessels in which cancer has arisen are concentrated. The latter binds to albumin in blood and exhibits a similar effect. Although in the case of these molecules the fluorescence is observed using a CCD or the like, it is possible to perform imaging in which the sensitivity is more enhanced compared to the contrast produced by the refractive index of the tissue itself by a spectrum in the terahertz region.

Molecular probes used as a contrast medium for MRI are also available as target molecules that can be used with the present invention. For example, ferucarbotran (trade name: Resovist (registered trademark)) that includes SPIO as a main constituent is incorporated into Kupffer cells, which are hepatic endothelial cells, and is selectively incorporated into healthy cells. That is, ferucarbotran is excluded from a cancer cell that is an abnormal site, and thus exhibits a contrast effect with respect to cancer cells. Further, a substance that includes gadopentetate dimeglumine as a main constituent (trade name: Magnevist) is, conversely, selectively incorporated into hepatic cancer cells. Furthermore, Sonazoid (registered trademark) and Levovist and the like that are used for ultrasound imaging can also be similarly applied.

That is, since it is possible to perform imaging in which the sensitivity is enhanced compared to the contrast produced by the refractive index of the tissue itself by a spectrum in the terahertz region, discriminative imaging by means of a comparatively small signal for a terahertz amplitude for which importance is placed on resolution is enabled.

### Embodiment 2

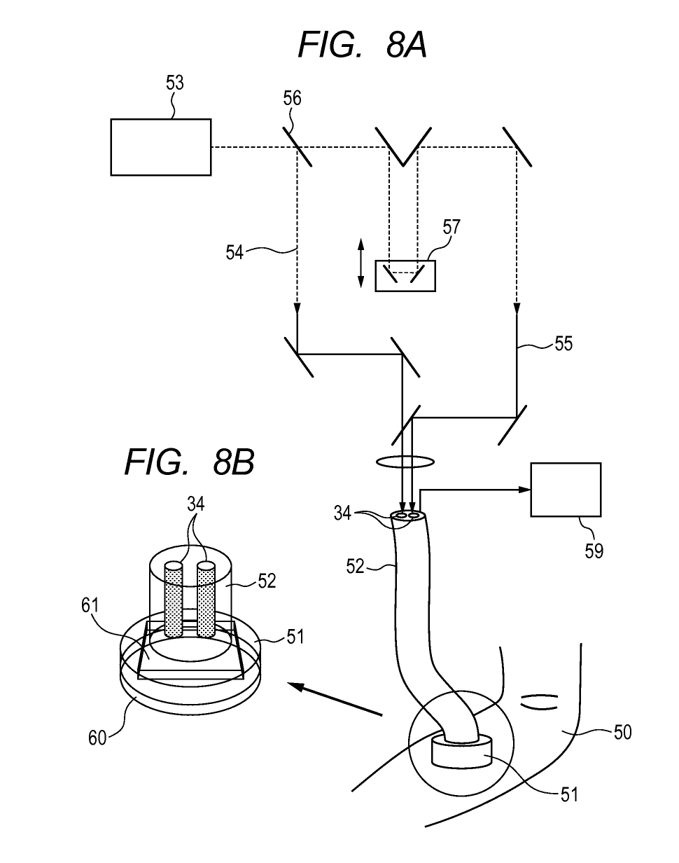

Embodiment 2 according to the present invention will now be described using FIG. 8A. According to the present embodiment, optical fibers, not a terahertz waveguide, are used as a probe 52. Although the THz-TDS system is basically the same as in Embodiment 1, light of a femtosecond laser 53 is divided into pump light 54 and probe light 55 by an optical divider 56, and the pump light 54 and probe light 55 are propagated as far as a distal end section 51 of a probe by two optical fibers 34. A generation section and a detection section are provided at the distal end section 51 of the probe, and the distal end section 51 has a terahertz wave introduction/emission function. A similar delay stage 57 to that provided in Embodiment 1 is also provided.

FIG. 8B illustrates an enlarged view of the distal end section 51 of the probe. In FIG. 8B, the distal ends of the optical fibers 34 are mounted so that light couples with a photoconductive element 61 similarly to Embodiment 1. The photoconductive element 61 is a component in which two elements are made on the same substrate, in which a terahertz wave is generated from an element that is coupled to the optical fiber that propagates the pump light 54, and a terahertz wave is detected with an element that is coupled to the optical fiber that propagates the probe light 55. Note that, the terahertz generation section and detection section are not limited to a photoconductive element, and an element made using nonlinear crystal (DAST, GaP, LiNbO and the like), or with respect to generation from a nonlinear element, an electrooptic Cerenkov generation-type element can be favorably used. A window 60 may also be formed at a part of the distal end section 51 of the probe that contacts the test object. Silicon, Z-cut quartz, sapphire, a tetrafluoroethylene-olefin resin or the like through which a terahertz wave is easily transmitted are suitable as the material of the window 60. If necessary, a lens structure (not shown) may also be inserted between the window 60 and the element 61. Reference numeral 50 denotes a state in which inspection of skin is being performed on the forearm of a human. Image processing for terahertz imaging is performed by sending a signal to a signal acquisition and processing section (control and processing section) 59 using electric wiring (unshown) that has been inserted inside the probe 52.

Since, propagation loss is small in the optical fibers in comparison to Embodiment 1, the present embodiment is suitable to a case where a long probe is required. However, it is necessary to select the fiber in consideration of the influence of scattering at the time of light propagation in the optical fibers 34.

### Embodiment 3

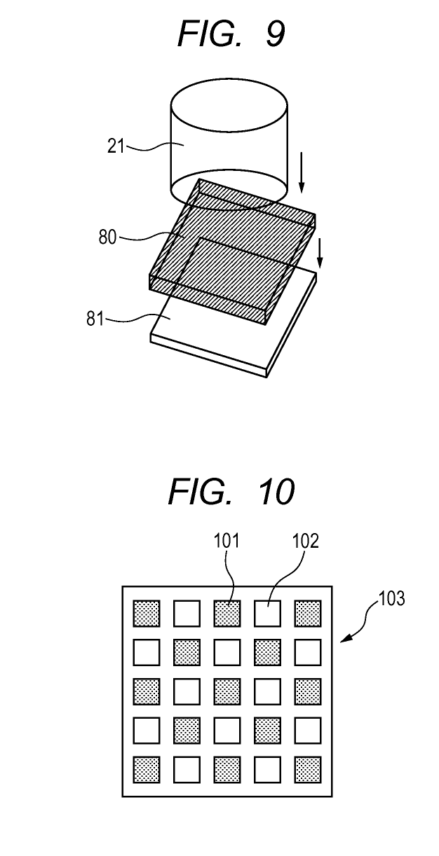

Embodiment 3 according to the present invention has a structure in which, as shown in FIG. 9, a filter structure is added to the distal end section of the probe of Embodiment 1. Reference numeral 21 denotes a probe that includes fiber or the like that can propagate terahertz waves that is the same as in Embodiment 1, and a spatial filter that uses a conductive material, for example, a metal hole-array filter 80, can be installed at the distal end thereof. This may also be a mesh-like filter. That is, the present embodiment includes a spatial filter in which a conductive material is used as units for extracting a signal of a wavelength component of a characteristic portion of the wavelength spectrum of a target material from a terahertz wave that the detection section detects. Further, a window material 81 such as a film that is transparent to terahertz waves (film made of polyvinylidene chloride or the like) or a quartz plate, a silicon plate or a resin plate may be provided between a contact section of the test object and the filter so that the filter characteristics are not altered by the test object. Although in FIG. 9 the components are represented as being the separate to each other to facilitate understanding, in practice the components are assembled and integrated in the manner indicated by the arrows.

When performing the spectral filter processing described in Embodiment 1, if the processing is performed so as to allow a signal to pass through the filter 81 so as to emphasize the characteristic spectrum portion of the target molecule, filter processing by means of signal processing need not be performed. If the filter is constructed so as to enable detachment and replacement thereof, the filter can be adapted to the sequence of processing described in FIG. 7 of Embodiment 1 or to a case where a target molecule is changed.

### Embodiment 4

Embodiment 4 according to the present invention will now be described using FIG. 10. Although in the foregoing embodiments measurement was performed using terahertz wave pulses by means of a THz-TDS device, in the present embodiment measurement is performed using a continuous wave that is a terahertz wave. A resonant tunnel diode oscillator, a quantum cascade laser and the like are available as generation units for generating a continuous terahertz wave. A light source is provided that oscillates at an oscillation frequency that corresponds to the absorption spectrum of the target molecule. It is also good to provide an oscillator having an oscillation frequency that can be used as a reference beam that is not involved in absorption. This similarly applies to the detection section. A CMOS-type, Schottky-type, or HEMT-type detection section or the like can be used as the detection section. To improve the sensitivity, these can also be made resonance-type components by setting a specific frequency to the frequency of the light source.

An example in which oscillators and detection sections are arranged in a staggered form on one surface is illustrated in FIG. 10. In this example, oscillators 101 and detection sections 102 are integrated on a single substrate 103. These elements may be integrated monolithically, or this arrangement may be adopted by dicing the respective elements and performing hybrid packaging thereof. When using the present element, for example, the element may be embedded in the distal end section 22 of the probe in FIG. 1. In this case, with respect to driving of the present element, only electric wiring is present inside the probe, and thus the probe 21 can be made extremely thin (3 mm or less) and lightweight. That is, the probe 21 is extremely useful when used for an endoscope. In this case also, a plurality of kinds of terahertz waves are irradiated at the test object from the oscillator 101, terahertz waves from the test object are detected by the detection section 102, and information such as image information is acquired by a processing section that performs processing using the detected signals and various kinds of stored data.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the embodiments of the present invention, information acquisition such as detection of a specific portion such as an abnormal site of a test object can be performed with favorable sensitivity without radiation exposure. Thus, with regard to information acquisition, for example, it is possible to improve the sensitivity when acquiring images including a tomogram of a test object, and also shorten the time required for image formation (improve work efficiency). These effects are particularly noticeable when the test object is biological tissue, since the amount of attenuation of terahertz waves is large.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2012-243215, filed Nov. 4, 2012, and No. 2013-209339, filed Oct. 4, 2013 which are hereby incorporated by reference herein in their entirety.

What is claimed is:

1. A subject information acquiring apparatus comprising:
a generation section that generates terahertz waves to be irradiated at a test object in a plurality of kinds of states including a state in which a target material that takes a specific portion of the test object as a target has been introduced into the test object;
a detection section that detects terahertz waves that are propagated from the test object and outputs a signal;
a processing section that acquires information of the test object using the signals detected by the detecting section and information relating to a characteristic portion of a wavelength spectrum of the target material.

2. The subject information acquiring apparatus according to claim 1,
wherein the generation section changes an intensity of a pulsed or a continuous terahertz wave in accordance with the state of test object.

3. The subject information acquiring apparatus according to claim 1,
wherein the generation section generates a pulsed terahertz wave and changes pulse width of the terahertz wave to be irradiated onto the test object in accordance with the state of test object.

4. The subject information acquiring apparatus according to claim 2,
wherein, when the intensity of the terahertz wave is changed in accordance with the state of test object, the intensity is lowered to decrease a pulse width, thereby a spatial range from which the information of the test object is acquired is reduced in order to increase spatial resolution.

5. The subject information acquiring apparatus according to claim 1,
wherein the processing section further comprises a unit that extracts a signal of a wavelength component of the characteristic portion of the wavelength spectrum of the target material from the signal that the detection section outputs.

6. The subject information acquiring apparatus according to claim 1, further comprising, as a unit for extracting a signal of the wavelength component of the characteristic portion of the wavelength spectrum of the target material from the terahertz wave that the detection section detects, a spatial filter in which a conductive material.

7. The subject information acquiring apparatus according to claim 1,
wherein the processing section acquires information of one of the test object in a state that the target material is applied and a state that the target material is introduced and then excreted.

8. The subject information acquiring apparatus according to claim 1,
wherein the target material comprises a substance that selectively remains at a specific portion or a substance that selectively remains at a place other than the specific portion.

9. The subject information acquiring apparatus according to claim 1,
wherein the generation section and the detection section are provided at a distal end section of a probe that has a terahertz wave introduction/emission function.

10. The subject information acquiring apparatus according to claim 9,
wherein the generation section that is provided at the distal end section of a probe is a terahertz oscillator, and
wherein the probe comprises an electric wiring for electrically connecting the oscillator.

11. The subject information acquiring apparatus according to claim 1,
wherein the information of the test object is image information that includes the specific portion.

12. The subject information acquiring apparatus according to claim 1, further comprising a storage section that stores data including the information relating to the characteristic portion of the wavelength spectrum of the target material.

13. A subject information acquiring method, comprising,
irradiating terahertz waves at a test object in a plurality of kinds of states including a state in which a target material that takes a specific portion of the test object as a target is introduced into the test object;
detecting terahertz waves that are propagated from the test object;
providing data including information relating to a characteristic portion of a wavelength spectrum of the target material; and
acquiring information of the test object using signal of the detected terahertz wave and the provided data.

14. The subject information acquiring method according to claim 13,
wherein, in the irradiating, an intensity of the terahertz wave is changed for each of a state of the test object that the target material is not introduced, the test object is introduced, and the test object is introduced and excreted, and in the detecting, each terahertz wave that is propagated from the test object is detected.

15. The subject information acquiring method according to claim 13,
wherein, in the providing, a wavelength spectrum of the target material that is previously measured are stored is provided, and in the acquiring, the data is read out to acquire image information of the target material.

16. A non-transitory program for acquiring information of a test object, that causes a computer for acquiring information of the test object by irradiating terahertz waves at the test object having a specific portion to execute the imaging method according to claim 13.
